(19) United States
(12) Patent Application Publication
(10) Pub. No.: US 2024/0055934 A1
(43) Pub. Date: Feb. 15, 2024

(54) STATOR HAVING AT LEAST ONE VIBRATION MITIGATION PORTION

(71) Applicant: BorgWarner Inc., Auburn Hills, MI (US)

(72) Inventor: Andrew Dragon, Fishers, IN (US)

(21) Appl. No.: 17/884,191

(22) Filed: Aug. 9, 2022

(51) Int. Cl. H02K 5/24; H02K 1/16; H02K 15/02

(52) U.S. Cl. CPC H02K 5/24; H02K 1/16; H02K 15/024

(57) ABSTRACT

A stator for an electric machine includes a stator body having a cylindrical yoke having a first diameter and a second diameter, a tooth portion having a plurality of slots extending radially from the first diameter, and at least one vibration mitigation portion including at least one gap in the yoke portion. The at least one gap extends radially from the first diameter to the second diameter, and the at least one gap has a width selected to mitigate vibration when the electric machine is operating at a selected operation frequency.

### BACKGROUND

Electric machines are employed in various applications. For example, electric machines are used as electric drive motors in electric and hybrid vehicles. An electric motor includes, among other components, a stator, windings, and a rotor. The stator may be configured as a stack of laminations (stator stack). Each lamination is typically formed of laminated sheets of electrically conductive material (e.g., steel) that is formed (e.g., stamped, rolled or bent) into an annulus shape. The laminations form a stator stack that includes a back-iron or yoke portion, and a tooth portion that includes slots open to an inside diameter (ID) or an outside diameter (OD).

The yoke carries electromagnetic flux and facilitates mounting the stator. The yoke has a hollow cylindrical shape that has a zero mode resonant frequency that typically resides within an operating speed of the electric motor and can generate unwanted levels of vibration and noise.

### SUMMARY

A stator for an electric machine, in accordance with a non-limiting example, includes a stator body having a cylindrical yoke having a first diameter and a second diameter, a tooth portion having a plurality of slots extending radially from the first diameter, and at least one vibration mitigation portion including at least one gap in the yoke portion. The at least one gap extends radially from the first diameter to the second diameter, and the at least one gap has a width selected to mitigate vibration when the electric machine is operating at a selected operation frequency.

A method of manufacturing a stator body of an electric machine, in accordance with anon-limiting example, includes forming a plurality laminations, each lamination having a cylindrical portion and a plurality of slot portions extending radially from the cylindrical portion, each lamination having at least one slit extending radially through the cylindrical portion, and forming a stator body by stacking and bonding the plurality of laminations. The stator body includes a cylindrical yoke formed from the cylindrical portions and having a first diameter and a second diameter, a tooth portion having a plurality of slots extending radially from the first diameter, and at least one vibration mitigation portion including at least one gap in the yoke. The at least one gap is formed by the at least one slit of the plurality of stacked laminations, and the at least one gap has a width selected to mitigate vibration when the electric machine is operating at a selected operation frequency.

An electric machine, in accordance with a non-limiting example, includes a rotor and a stator body having a plurality of conductors configured as windings. The stator body includes a cylindrical yoke having a first diameter and a second diameter, a tooth portion having a plurality of slots extending radially from the first diameter, and at least one vibration mitigation portion including at least one gap in the yoke. The at least one gap extends radially from the first diameter to the second diameter, the at least one gap having a width selected to mitigate vibration when the electric machine is operating at a selected operation frequency. The stator body includes a first body section having a first vibration mitigation portion and a second body section having a second vibration mitigation portion, the first vibration mitigation portion offset in a circumferential direction from the second vibration mitigation portion.

### BRIEF DESCRIPTION OF THE DRAWINGS

FIG. 1 depicts a stator assembly for an electric motor, which includes a stator stack and a winding, in accordance with an aspect of an exemplary embodiment;

FIGS. 2A and 2B depict a stator lamination including a vibration mitigation portion, in accordance with an aspect of an exemplary embodiment;

FIGS. 3A and 3B depict a stator body section formed by a plurality of laminations, in accordance with an aspect of an exemplary embodiment;

FIGS. 4A and 4B depict a stator body having a plurality of stator body sections and forming offset or interleaved vibration mitigation portions, in accordance with an aspect of an exemplary embodiment;

FIG. 5 depicts a stator body, in accordance with an aspect of an exemplary embodiment;

FIG. 6 depicts a stator body, in accordance with an aspect of an exemplary embodiment; and

FIG. 7 is a flow diagram depicting a method of manufacturing a stator, in accordance with an aspect of an exemplary embodiment.

### DETAILED DESCRIPTION

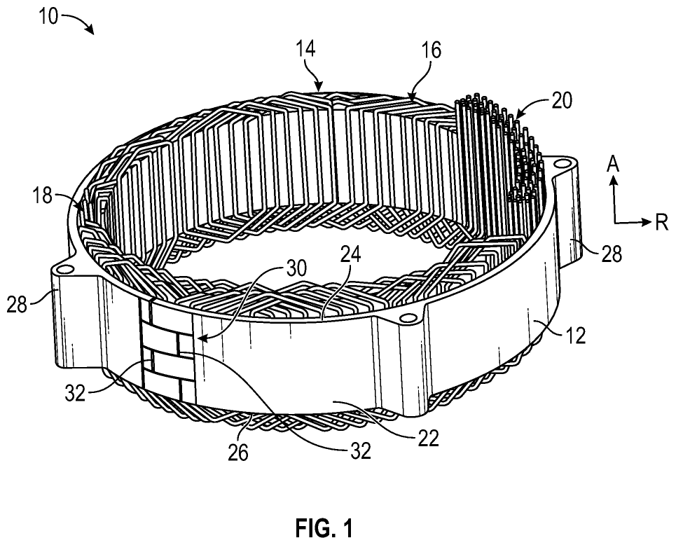

A stator assembly for an electric machine is indicated generally at 10 in FIG. 1. The stator assembly 10 includes a stator body 12 that supports windings 14 formed from a plurality of conductors 16. The windings 14 include a section 18 and a connector lead section 20. The stator body 12 may be formed from an electrically conductive material, such as steel. The stator body 12 includes a back-iron portion or yoke 22 that forms a hollow cylinder, and includes a tooth portion formed by a plurality of slots (not shown) and extending from the yoke 22 toward an interior diameter of the stator body. The yoke 22 in this embodiment has a thickness in an axial direction (in a direction A parallel to a rotational axis of the stator body 12) from a bottom surface 24 to a top surface 26. The stator body 12 also may include a set of mounting features 28 on the outer diameter for mounting the stator assembly in a motor or other electric machine.

The stator body 12 also includes one or more vibration mitigation portions 30 configured to mitigate (i.e., reduce or minimize) vibrations when the electric machine is in operation. Each vibration mitigation portion 30 includes a gap 32 that extends radially (i.e., in a radial direction R) from a first diameter of the yoke 22 (e.g., an OD) to a second diameter of the yoke 22 (e.g., an ID). Each gap 32 also extends axially (i.e., in the axial direction A). A gap 32 may be a single continuous gap extending axially from the top surface 24 to the bottom surface 26, or a continuous gap that extends along part of the thickness.

There may be any number of gaps 32 in a given vibration mitigation portion 30. For example, as shown in FIG. 1, the mitigation portion 30 includes a set of interleaved gaps 32, in which each gap 32 is offset in a circumferential or angular direction relative to an adjacent gap 32.

Embodiments are not limited to the configuration shown in FIG. 1. For example, the stator body 12 could have a tooth portion that extends outwardly from the yoke 22. In addition, the stator body 12 may have any number of mitigation portions 30, and may have any number of gaps 32 in a given mitigation portion 30.

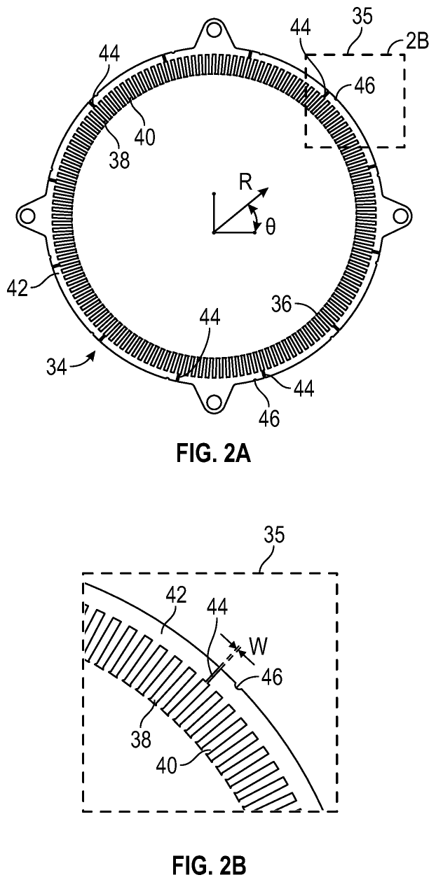

The stator body 12 is constructed by forming a plurality of laminations, and stacking and bonding the laminations. An example of a lamination 34 is shown in FIGS. 2A and 2B. FIG. 2A shows the lamination 34 and FIG. 2B shows a close-up view of a region 35 of the lamination 34. The lamination 34 is formed from a thin sheet of conductive material. The lamination 34 may have a thickness of between about 0.1 and about 0.5 mm (e.g., about 0.3 mm). An inner portion 36 includes a plurality of radially extending portions 38 having slot portions 40 therebetween. When a plurality or group of the laminations 34 are stacked, the inner portions 36 form slots and teeth of the stator body 12. An outer cylindrical portion 42 forms the yoke 22 when laminations 34 are stacked.

The lamination 34 also includes a plurality of slits 44 arrayed circumferentially or angularly (e.g., in an angular direction θ) in the outer portion 42. In an embodiment, each slit 44 is positioned such that the slit 44 extends radially from an outer surface of the outer portion 42 to a slot portion 40 so that the slit 44 terminates between adjacent radially extending portions 38.

Each slit 44 has a width W. When laminations 34 are stacked, the slits 44 form a gap 32 having the width W. The width W is selected so that the resonant frequency mode zero of the stator body 12 shifts from a normal operating frequency to a different frequency (e.g., a frequency that a motor does not operate in or rarely operates in). For example, the width W is selected to shift the mode zero frequency from a frequency in a range including about 3000-6000 Hz to a range including about 10-50 KHz. The width is, for example, between about 0.05 mm and 1 mm (e.g., about 0.3 mm or width of a stamping blade used to form the slit 44).

In the lamination 34 shown on FIGS. 2A and 2B, the slits 44 are positioned equidistantly along a circumferential or angular direction θ. For example, as shown, the lamination 34 includes twelve slits 44, each separated by the same angular distance. However, the lamination 34 is not so limited, and can have any number of slits 44 at any desired positions. For example, each lamination 34 has as few as one or two slits 44 (e.g., to limit manufacturing complexity), which results in a section of the stator body 12 having one or two mitigation portions 30.

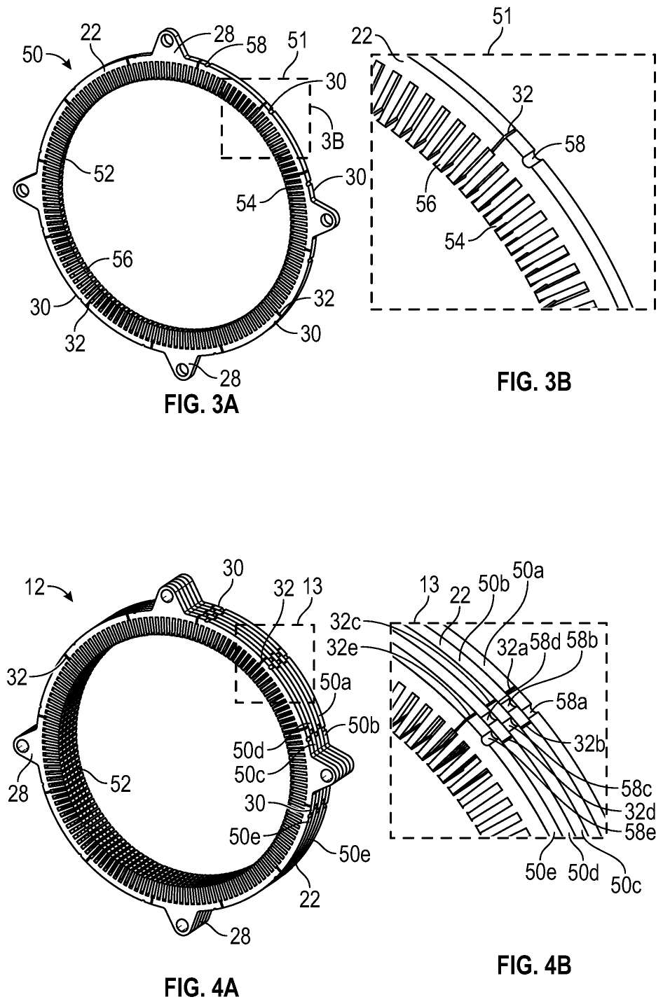

The vibration mitigation portion 34 may include additional features to facilitate construction. For example, as shown in FIGS. 2A and 2B, an indentation 46 is formed to facilitate aligning individual laminations 34 to ensure that the slits 44 are properly aligned. The indentations 46 form an alignment feature (See FIGS. 3A and 3B) when stacked, which can be used to align sections of the stator body 12 stack sections in an interleaving configuration or other configuration.

As noted above, individual laminations 34 are stacked and bonded to construct the stator body 12 or section thereof. In an embodiment, the stator body 12 is constructed by attaching multiple body segments together, where each body segment has one or more vibration mitigation portions.

FIGS. 3A and 3B depict an embodiment of a stator body section 50 formed by stacking and bonding laminations 34. The bonding process may include pins, interlocks, welds and/or an adhesive. FIG. 3A shows the stator body section 50 and FIG. 3B shows a close-up view of a vibration mitigation portion 30 in a region 51. The body section 50 includes the yoke 22 (or section of the yoke 22) formed by outer portions 42 of the laminations 34, and a tooth portion 52 (or section of the tooth portion 52). The tooth portion 52 is formed by the radially extending portions 38 of the laminations 34, and includes slots 54 and teeth 56.

The yoke 22 also includes the vibration mitigation portions 30. As shown, each gap 32 extends radially from an outer edge of the yoke 22 to an inner edge between two adjacent teeth 56. Each mitigation portion 30 may also include an alignment feature 58 formed by the indentations 46.

FIGS. 4A and 4B show an embodiment of the stator body 12 constructed of a plurality of stator body sections 50. FIG. 4A shows the stator body 12 and FIG. 4B shows a close-up view of a vibration mitigation portion 30 in a region 13. In this embodiment, the stator body 12 includes five stator body sections 50, denoted as sections 50a-50e. Stator section 50a includes a mitigation portion 30a including a gap 32a and an alignment feature 58a, stator section 50b includes a mitigation portion 30b including a gap 32b and an alignment feature 58b, and stator section 50c includes a mitigation portion 30c including a gap 32c and an alignment feature 58c. Stator section 50d includes a mitigation portion 30d including a gap 32d and an alignment feature 58d, and stator section 50e includes a mitigation portion 30e including a gap 32e and an alignment feature 58e. It is noted that the stator body 12 is not limited to this configuration and can have any number of body sections 50 and mitigation portions 30.

As shown, the mitigation portions 30 are interleaved or alternating, such that a given mitigation portion is circumferentially or angularly offset from each adjacent mitigation portion 30. For example, gaps 32a, 32c and 32e are aligned, and gaps 32b and 32d are offset to create an alternating configuration. The alignment features 58a-58e similarly alternate. As shown, the gaps 32 may be alternating but also placed in close circumferential proximity to each other. The gaps 32 shown in FIGS. 4A and 4B are located with only two teeth 56 between the set of gaps 32a, 32c, 32e and the set of gaps 32b and 32d. However, embodiments are not so limited, as there may be any number of teeth 56 between sets of gaps in a mitigation portion 30. In addition, the embodiment of FIGS. 4A and 4B, the mitigation portions 30 are arrayed such that they are separated by twelve teeth 46 (i.e., have twelve teeth between successive mitigation portions). However, the mitigation portions 30 can be separated by any number of teeth and by any angular distance. For example, the mitigation portions 30 can be positioned to have six (or less than seven) teeth 56 between successive portions 30.

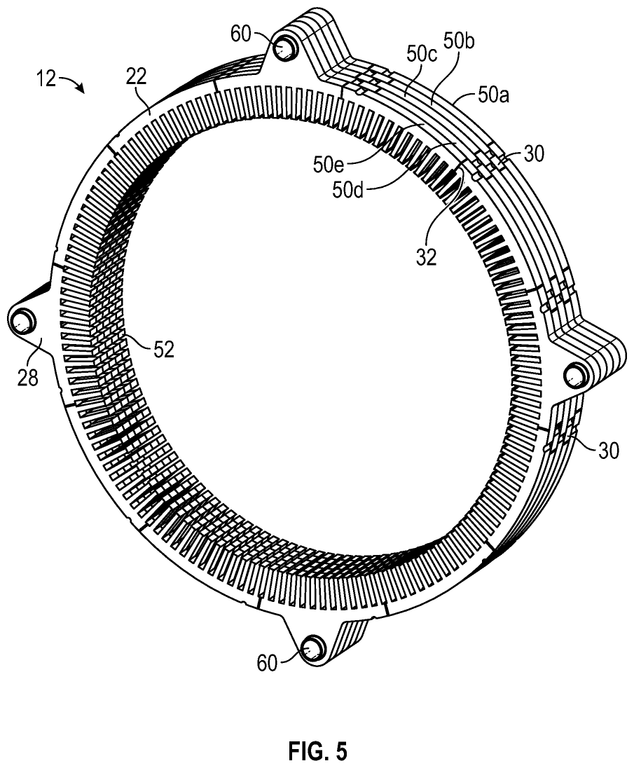

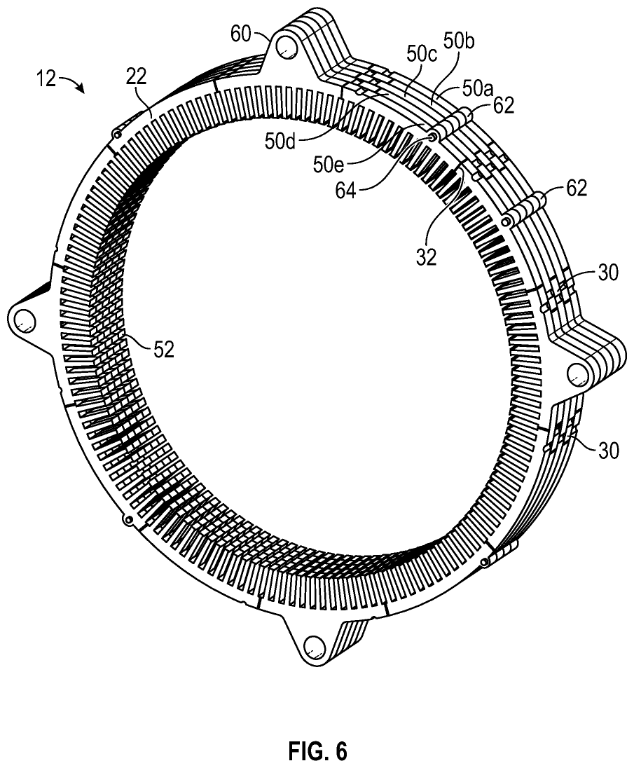

FIGS. 5 and 6 depict examples of alternate configurations of the stator body 12. In FIG. 5, the stator body sections 50a-50e are held together via hollow pins 60 through the mount features 28. In FIG. 6, the stator body sections 50a-50e are held together by solid pins 62 through mounting features 64.

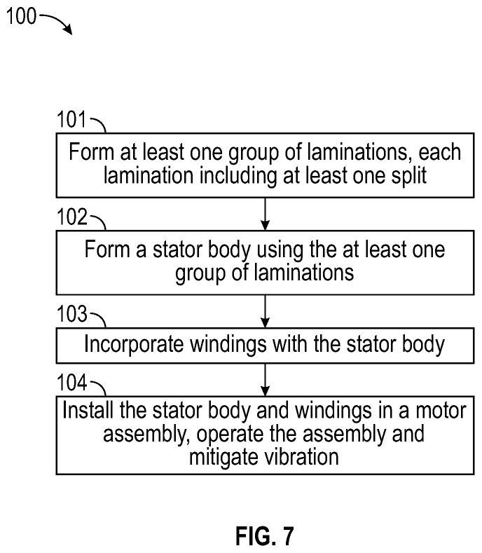

FIG. 7 illustrates embodiments of a method 100 of manufacturing a stator assembly (stator body with windings) and/or operating an electric machine, e.g., an electric motor. The method 100 includes a number of steps or stages represented by blocks 101-104. The method 100 is not limited to the number or order of steps therein, as some steps represented by blocks 101-104 may be performed in a different order than that described below, or fewer than all of the steps may be performed.

At block 101, at least one group of laminations is formed by stamping, rolling, cutting or otherwise forming each lamination from a sheet of conductive material. During or after forming a lamination, at least one split is formed. For example, a circumferential array of slits is formed by a punch die, laser cut, water jet, machining (e.g., electrical discharge machining or EDM) or any other suitable technique or combination of techniques. In an embodiment, a group of laminations are aligned and attached together using any suitable technique(s) to form a body section. Examples of such techniques include bonding, welding and interlocking.

In an embodiment, a plurality of groups of laminations are formed, where each group of laminations has at least one slit formed at the same circumferential location or locations. For example, each of a first group of laminations has a set of slits formed at a first set of circumferential locations. A second group of laminations has a set of slits formed at a second set of locations, where the first set of locations is offset from the second set of locations.

If desired, an additional group or additional groups of laminations may be formed, where each set of laminations has slits at a respective set of circumferential locations. The first, second and additional group(s) are aligned when their respective body sections are arranged together to form a set of interleaving or alternating slots as discussed above.

At block 102, if multiple body sections are constructed, the body sections are aligned and attached together using any suitable technique(s) to form the stator body. Examples of such techniques include bonding, welding and interlocking. In an embodiment, the body sections are not attached at locations within vibration mitigation portions or at slots.

At block 103, windings are formed by inserting conductors into the slots, opened to the inside diameter, of the stator body. The combination of the stator body and windings forms a stator assembly (e.g., the stator assembly 12). The stator assembly may also include insulating parts and a resin part.

At block 104, the stator assembly is installed with a rotor and other suitable components to construct a motor assembly. The motor assembly may then be installed in a vehicle or other system and operated accordingly. During operation, the mitigation portion(s) described herein reduce vibrations by shifting the zero mode frequency away from the motor assembly's operating frequency.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A stator for an electric machine, comprising:
a stator body including:
a cylindrical yoke having a first diameter and a second diameter;
a tooth portion having a plurality of slots extending radially from the first diameter; and
at least one vibration mitigation portion including at least one gap in the yoke portion, the at least one gap extending radially from the first diameter to the second diameter, the at least one gap having a width selected to mitigate vibration when the electric machine is operating at a selected operation frequency.

2. The stator of claim 1, wherein the first diameter is an inner diameter of the yoke.

3. The stator of claim 1, wherein the at least one gap extends axially along a thickness of the yoke.

4. The stator of claim 3, wherein the at least one gap extends radially to an edge of the yoke between adjacent teeth of the tooth portion.

5. The stator of claim 1, wherein the at least one vibration mitigation portion includes a plurality of mitigation portions arrayed along a circumference of the yoke.

6. The stator of claim 1, wherein the stator body is formed from a plurality of laminations, and the vibration mitigation portion is formed by at least one group of laminations, the at least one group of laminations forming at least one stator body section.

7. The stator of claim 5, wherein the stator body includes a plurality of stator body sections, each stator body section having at least one respective vibration mitigation portion and at least one respective gap.

8. The stator of claim 7, wherein the plurality of stator body sections includes a first stator body section having a first vibration mitigation portion and a second stator body section having a second vibration mitigation portion, the first vibration mitigation portion offset in a circumferential direction from the second vibration mitigation portion.

9. The stator of claim 8, wherein the plurality of stator body sections includes at least five stator body sections.

10. The stator of claim 9, wherein the stator body includes a plurality of vibration mitigation portions, and successive vibration mitigation portions are separated by fewer than seven teeth of the tooth portion.

11. The stator of claim 1, wherein the at least one gap has a width between about 0.05 mm to about 1 mm.

12. A method of manufacturing a stator body of an electric machine, comprising:
forming a plurality laminations, each lamination having a cylindrical portion and a plurality of slot portions extending radially from the cylindrical portion, each lamination having at least one slit extending radially through the cylindrical portion; and
forming a stator body by stacking and bonding the plurality of laminations, the stator body including:
a cylindrical yoke formed from the cylindrical portions and having a first diameter and a second diameter;
a tooth portion having a plurality of slots extending radially from the first diameter; and
at least one vibration mitigation portion including at least one gap in the yoke, the at least one gap formed by the at least one slit of the plurality of stacked laminations, the at least one gap having a width selected to mitigate vibration when the electric machine is operating at a selected operation frequency.

13. The method of claim 12, wherein the first diameter is an inner diameter of the yoke.

14. The stator of claim 12, wherein the at least one gap extends radially to an edge of the yoke between adjacent teeth of the tooth portion.

15. The method of claim 12, wherein the plurality of laminations includes at least a first group of laminations and a second group of laminations, each of the first group of laminations having at least one first slit, and each of the second group of laminations having at least one second slit.

16. The method of claim 15, wherein forming the stator body includes stacking and bonding the first group of lamination to form a first stator body section, and stacking and bonding the second group of laminations to form a second stator body section.

17. The method of claim 16, wherein forming the stator body includes aligning the first stator body section relative to the second stator body section, and bonding the sections to form offset vibration mitigation portions.

18. An electric machine comprising:
a rotor; and
a stator body having a plurality of conductors configured as windings, the stator body including:
a cylindrical yoke having a first diameter and a second diameter, the stator body including a tooth portion having a plurality of slots extending radially from the first diameter; and
at least one vibration mitigation portion including at least one gap in the yoke, the at least one gap extending radially from the first diameter to the second diameter, the at least one gap having a width selected to mitigate vibration when the electric machine is operating at a selected operation frequency;
wherein the stator body includes a first body section having a first vibration mitigation portion and a second body section having a second vibration mitigation portion, the first vibration mitigation portion offset in a circumferential direction from the second vibration mitigation portion.

19. The electric machine of claim 18, wherein each body section has a maximum of two mitigation portions arrayed along a circumference of the yoke portion.

20. The electric machine of claim 18, wherein the stator body sections are not attached within the at least one vibration mitigation portion.
